(19) United States
(12) Patent Application Publication
(10) Pub. No.: US 2018/0236572 A1
(43) Pub. Date: Aug. 23, 2018

(54) RECIPROCATING SAW

(71) Applicant: MAKITA CORPORATION, ANJO-SHI (JP)

(72) Inventor: Tomohiro UKAI, Anjo-Shi (JP)

(21) Appl. No.: 15/897,435

(22) Filed: Feb. 15, 2018

(30) Foreign Application Priority Data
Feb. 23, 2017 (JP) 2017-032549

(51) Int. Cl. B23D 51/16; B23D 49/16; B25F 5/02

(52) U.S. Cl. CPC B23D 51/16; B25F 5/02; B23D 49/167

(57) ABSTRACT

A reciprocating saw includes a motor having a rotor that is rotatable relative to a stator. A rotary shaft is fixedly connected to, and rotatably driven by the rotor. The rotary shaft has a rotational axis. A reciprocating-motion converting mechanism is driven by rotation of the rotary shaft, and a slider is reciprocally moved in a first direction by the reciprocating-motion converting mechanism. The rotational axis of the motor and the first direction form an angle of 45-135°.

### CROSS-REFERENCE

The present application claims priority to Japanese patent application serial number 2017-032549 filed on Feb. 23, 2017, the contents of which are incorporated fully herein by reference.

### TECHNICAL FIELD

The present invention relates to a reciprocating saw (also known as a “recipro saw”) that converts the rotation of a motor into the reciprocating motion of a slider and cuts a workpiece using a blade mounted on the slider.

### BACKGROUND ART

The reciprocating saw disclosed in Japanese Laid-open Patent Publication 2016-203283 and its family member US 2016/303668 houses a motor inside a housing and converts the rotation of a rotary shaft of this motor into the reciprocating motion of a slider using a reciprocating-motion converting mechanism, such as a crank mechanism. Therefore, a workpiece can be cut by a blade that is mounted on the slider. This reciprocating saw is structured such that: a crank, which comprises a bevel gear, is disposed forward of the motor, in which the rotary shaft is disposed such that it is oriented frontward. The rotary shaft meshes with the bevel gear. A connecting rod is coupled between an eccentric shaft of the crank and a rear end of the slider, whereby the rotation of the rotary shaft is converted into the reciprocating motion of the slider.

### SUMMARY

However, because the motor, the crank mechanism, and the slider of the above-described reciprocating saw are arranged lined up sequentially in the front-rear direction, the overall length of the reciprocating saw is long in the reciprocating-motion direction of the slider.

Accordingly, an object of the present teachings is to provide a reciprocating saw having a shorter overall length in the reciprocating-motion direction of the slider.

In a first aspect of the present teachings, a reciprocating saw comprises: a brushless motor comprising a stator and a rotor, which is rotatable relative to the stator and comprises a rotary shaft; a reciprocating-motion converting mechanism driven by the rotation of the rotary shaft; and a slider that is reciprocally moved (driven) in a front-rear direction by the reciprocating-motion converting mechanism. The brushless motor is disposed downward of the slider, with the rotary shaft oriented in the up-down direction.

In a second aspect of the present teachings, the reciprocating-motion converting mechanism is housed in a gear housing, from which the slider protrudes forward; the brushless motor is housed in a motor housing that is coupled to a lower portion of the gear housing; and the gear housing and the motor housing are housed in a main-body housing, which has a switch and a control circuit board disposed in a rear portion thereof.

In a third aspect of the present teachings, the gear housing extends in the front-rear direction and protrudes forward from the main-body housing; and the motor housing is connected (disposed) forward of the rear end of the gear housing.

In a fourth aspect of the present teachings, a reciprocating saw comprises: a motor comprising a stator and a rotor, which is rotatable relative to the stator and comprises a rotary shaft extending in an up-down direction; a pinion provided on (at) an upper end of the rotary shaft; a vertically oriented gear that meshes with the pinion and whose rotational axis is oriented in the left-right direction; an eccentric shaft that is provided on the gear and moves eccentrically around (orbits about) the rotational axis; and a slider that is reciprocally moved (driven) in the front-rear direction by the eccentric shaft.

In a fifth aspect of the present teachings, the motor is disposed downward of the rotational axis of the gear, and the pinion on the upper end meshes with a lower portion of the gear.

Because the motor is not located rearward of the reciprocating-motion converting mechanism, the gear, etc., the overall length of the reciprocating saw can be shortened in the reciprocating-motion direction of the slider. In addition or in the alternative, if the motor is brushless, then a lightweight and compact reciprocating saw can be achieved in the up-down direction.

### BRIEF DESCRIPTION OF THE DRAWINGS

FIG. 1 is an oblique view of a reciprocating saw according to a representative, non-limiting example of the present teachings.

FIG. 2 is a center longitudinal-cross-sectional view of the reciprocating saw of FIG. 1.

FIG. 3 is a cross-sectional view taken along line A-A shown in FIG. 2.

FIG. 4 is a cross-sectional view taken along line B-B shown in FIG. 2.

FIG. 5 is a cross-sectional view taken along line C-C shown in FIG. 3.

### DETAILED DESCRIPTION OF THE EMBODIMENTS

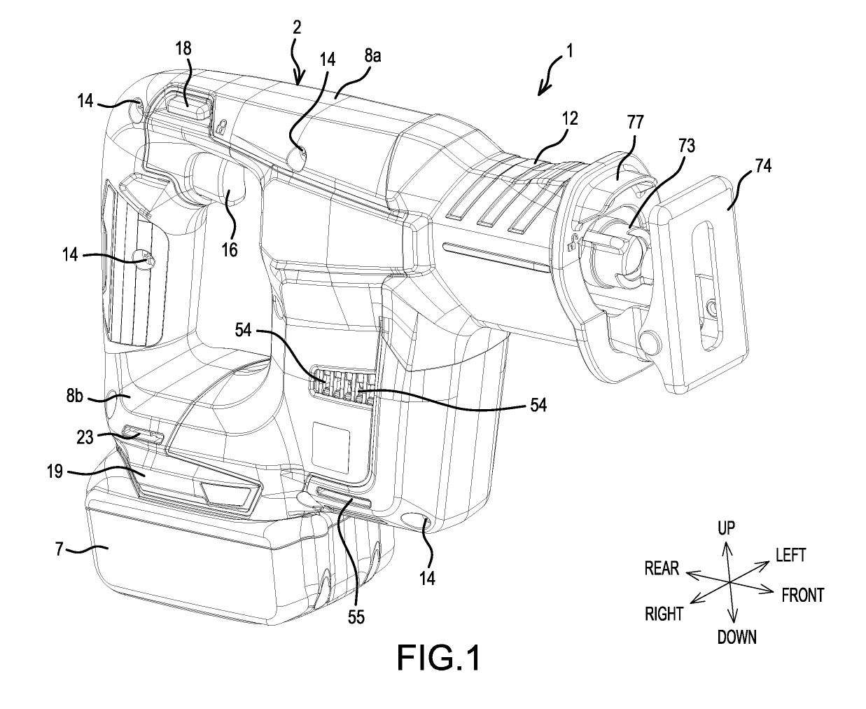

Representative embodiments of the present teachings are explained below, with reference to FIGS. 1-5, which show a reciprocating saw 1 that comprises a motor 2, a reciprocating-motion converting mechanism 3, a slider 4, a switch 5, a controller 6, and a battery pack 7.

A housing of the reciprocating saw 1 comprises: a main-body housing 8, which is generally quadrangular in a side view; and a gear housing 9 that houses the reciprocating-motion converting mechanism 3. The gear housing 9 includes a rear-half portion 10 held by an upper-side front portion of the main-body housing 8 and a front-half portion 11 that protrudes forward from the main-body housing 8. A tube-shaped insulation cover 12 is mounted around the exterior of the front-half portion 11.

The main-body housing 8 is divided into left and right half housings (housing halves) 8a, 8b, and these half housings 8a, 8b are joined (assembled) by screwing in screws 14, 14, . . . , from the right side, at the positions of (into) screw bosses 13, 13, . . . , which each project from an inner surface and mate together. A loop-shaped handle part (handle) 15 is formed at (along) a rear portion of the main-body housing 8. The switch 5, from which a trigger 16 projects forwardly, and a capacitor 17, which is located therebelow, are housed inside the handle part 15. A lock-off button 18 is slidable left and right from a position, at which the trigger 16 is blocked from being pushed in, to a position that releases the blocking (i.e. where the trigger 16 can be depressed/squeezed to actuate the motor 2).

In addition, a battery-mount part 19, on which the battery pack 7 (e.g., a battery having a rated voltage of 18V) is slidably mounted from the rear, is formed downward of the handle part 15. A terminal block 20, which electrically connects to the battery pack 7, and the controller 6, which is located thereabove, are housed inside the battery-mount part 19. The controller 6 comprises a control circuit board 21, on which a microcontroller, a switching device, and the like (not shown) are installed. The controller 6 is supported in the front-rear direction by ribs 22, 22, which have an inverted U shape and are provided such that they extend vertically upward from the inner surfaces of the half housings 8a, 8b. On the left and the right of the controller 6, rear air-suction ports 23, 23 are formed in the side surfaces of the main-body housing 8 and extend in the front-rear direction.

The gear housing 9 has a bottomed tube shape, which means that the rear-half portion 10 is closed up and a front end of the front-half portion 11 is open. Interior housings 9a, 9b, which are the divided left and right halves of the gear housing 9, are joined (assembled) by screws 24, 24, . . . . Screw-fastening protuberances 25, 25, . . . , which are provided for fixing (joining) the interior housings 9a, 9b using the screws 24, are respectively provided such that they project from the outer circumference of the rear-half portion 10 of the interior housings 9a, 9b. The rear-half portion 10 is circular in side view and conforms to the circular outer shape of the bevel gear 60 (described below). Screw-fastening parts 26, 26, . . . , which are provided for fixing (joining) the interior housings 9a, 9b using the screws 24, are also formed at prescribed positions along upper and lower end edges of the front-half portion 11.

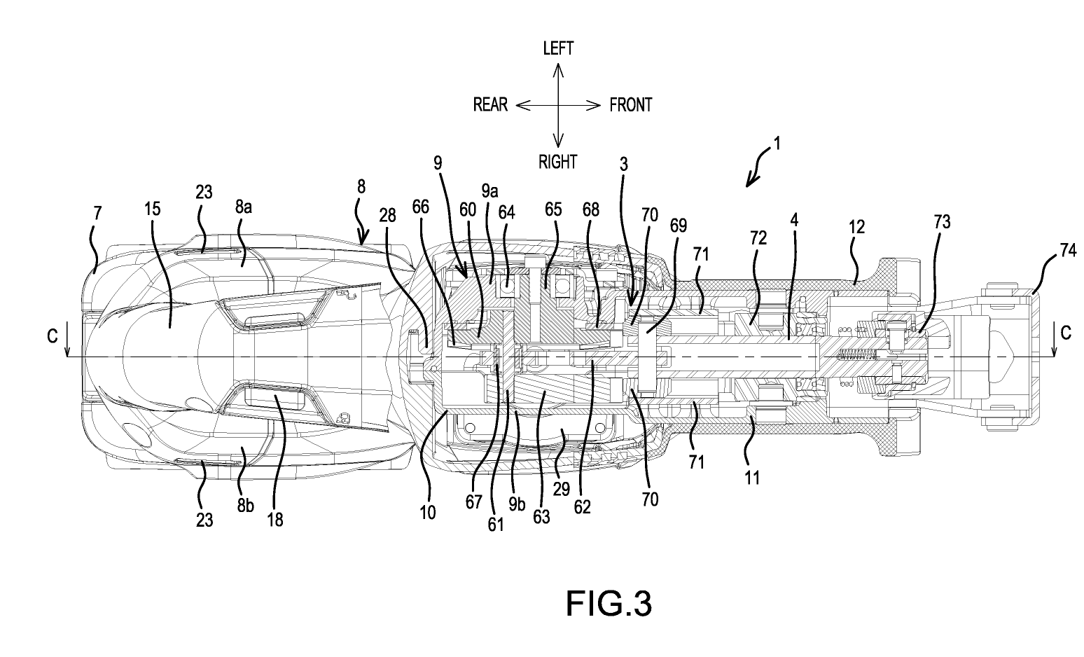

In addition, mating tubes 27, 27, . . . are located in correspondence with the positions of the screw bosses 13 provided on the main-body housing 8, and are provided such that they project from the rear-half portion 10 at two locations on the front and the rear of the lower side and one location on the upper side of the rear-half portion 10. The rear-half portion 10 is held inside the main-body housing 8 by respectively passing the screw bosses 13 through the mating tubes 27 until the screw bosses 13 make contact with stoppers (not shown) that are provided on the base sides of the screw bosses 13. Furthermore, as shown in FIG. 3, receiving ribs 28, 28, which respectively receive the mating tubes 27 on the rear surface and the rear lower side of the rear-half portion 10, are provided such that they project from the inner surfaces of the left and the right half housings 8a, 8b.

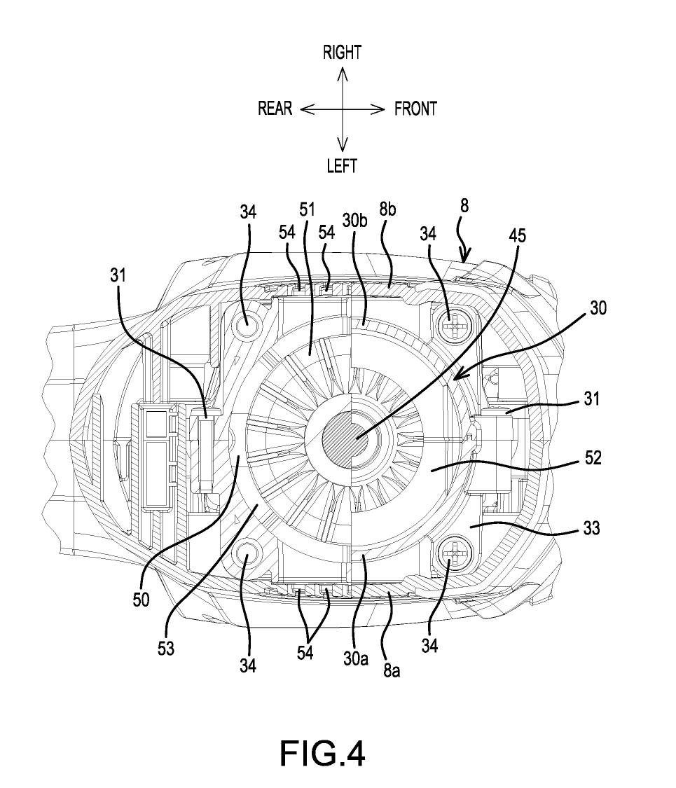

Inside the main-body housing 8, a motor housing 30, which houses the motor 2, is coupled to the rear-half portion 10 of the gear housing 9. As shown in FIG. 4, the motor housing 30 has a bottomed tube shape. More particularly, left and right half cases 30a, 30b of the motor housing 30 are joined (assembled) using upper screws 31, 31, which are oriented (extend) in the left-right direction and are disposed at the front and the rear on the upper side, and lower screws 32, 32, which are oriented (extend) in the left-right direction and are disposed in the front and the rear on the lower side. A motor-side flange 33 is formed at an upper end of the motor housing 30. The motor housing 30 is fixed, in the up-down direction, on the lower side of the rear-half portion 10 by attaching the four corners of the motor-side flange 33 to a gear-side flange 29, which is shaped similarly to the motor-side flange 33 and is provided on a lower end of the rear-half portion 10, using four attaching screws 34, 34, . . . from below. The motor-side flange 33 makes contact with the inner surfaces of the left and the right half housings 8a, 8b, whereby movement of the motor-side flange 33 in the left-right direction is prevented.

Because the motor housing 30 is joined to the gear housing 9 in this manner and thereby the two housings 30, 9 can be made into a unit, they can be conveniently assembled in (inserted into) the main-body housing 8 after the gear housing 9, which houses the reciprocating-motion converting mechanism 3, and the motor housing 30, which houses the motor 2, are manufactured as a unit.

The motor 2 is an inner-rotor type brushless motor comprising a tube-shaped stator 35 and a rotor 36, which passes through the stator 35. The stator 35 comprises: a stator core 37; an upper insulating member 38 and a lower insulating member 39, which are provided above and below the stator core 37; and a plurality of coils 40, 40, . . . , which are wound around the stator core 37 through (on, around) the upper and lower insulating members 38, 39. The stator 35 is held inside the motor housing 30. Three fusing terminals 41 are provided on the lower insulating member 39. One end of each of the three fusing terminals 41 sandwiches and is fused with the three respective wires leading (connected) to the coils 40, and the other end of each of the fusing terminals 41 protrudes rearward from the lower insulating member 39. These other ends are guided (inserted) into a coupling piece 43, which is provided on a rear surface of the motor housing 30 and protrudes from (through) an opening 42. A terminal unit 44, which is U-shaped in side view and to which power-supply lines of three phases corresponding to the fusing terminals 41 are soldered, is electrically connected to the coupling piece 43 with a screw so as to sandwich it from the rear. The power-supply lines that extend from the terminal unit 44 are connected to the rearward-located control circuit board 21 within the controller 6.

The rotor 36 comprises: a rotary shaft 45, which is located at (extends through) the axial (rotational) center of the rotor 36 and extends in the up-down direction; a tube-shaped rotor core 46, which is disposed around the rotary shaft 45; and four (not shown) permanent magnets, which are disposed inside the rotor core 46. A sensor circuit board 47, whereon three rotation-detection devices are installed that detect the positions of the permanent magnets of the rotor 36 and output rotation-detection signals, is affixed by screws to a lower end of the lower insulating member 39. Signal lines, which output the rotation-detection signals, are connected to a rear end of the sensor circuit board 47. Like the power-supply lines, these signal lines are also connected to the control circuit board 21.

The upper end of the rotary shaft 45 passes through the lower wall of the rear-half portion 10 of the gear housing 9 from below, protrudes inwardly into the gear housing 9, and is axially (rotatably) supported by an upper bearing 48, which is provided on a lower surface of the rear-half portion 10. The lower (opposite) end of the rotary shaft 45 is supported by a lower bearing 49, which is provided on an inner bottom surface of the motor housing 30. A plate-shaped bearing retainer 50 retains the upper bearing 48 and is bolted, from below, to the lower surface of the rear-half portion 10. Below the bearing retainer 50, a centrifugal fan 51 is attached to the rotary shaft 45. A fan housing chamber 53, the left and the right ends of which are open, is formed between a baffle 52 and the bearing retainer 50, which are provided inside the motor housing 30. Air-exhaust ports 54, 54, . . . are formed in the main-body housing 8 on the left and the right of the fan housing chamber 53, and front air-suction ports 55, 55 are formed in the front-rear direction below the motor housing 30 on the left and the right of the main-body housing 8.

As shown also in FIG. 3, the reciprocating-motion converting mechanism 3 comprises, inside the rear-half portion 10 of the gear housing 9: a bevel gear 60, an eccentric shaft 61, a connecting rod 62, and a counterweight 63. A leftward-projecting shaft 65 is rotatably supported by a bearing 64 provided (held) on the left side of the interior housing 9a. Therefore, the bevel gear 60 is vertically arranged such the rotational axis (shaft 65) of the bevel gear 60 extends in the left-right direction and a gear part (gear teeth) 66 faces towards the right side. Below the rotational axis of the bevel gear 60, a pinion 45a is provided on the upper end of the rotary shaft 45 and projects into the rear-half portion 10. The pinion 45a engages (meshes) with the gear part (gear teeth) 66 at a lower portion thereof. The rotating pinion 45a causes the bevel gear 60 to rotate in a vertical plane defined by the front-rear direction and the up-down direction.

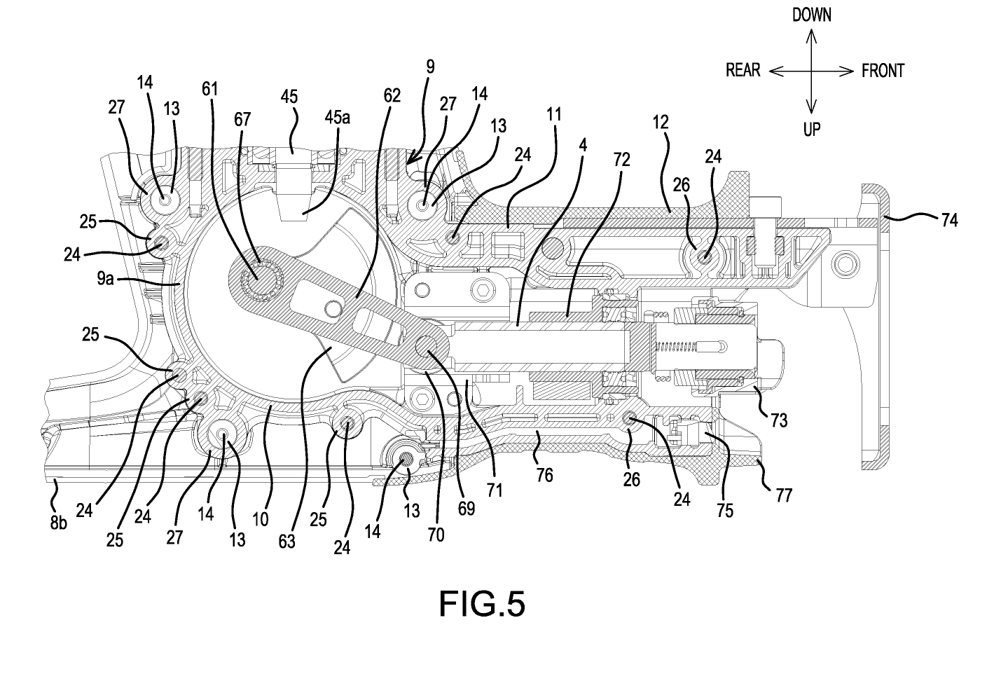

The eccentric shaft 61 extends in the left-right direction, and is affixed at (projects from) an off-center (eccentric) location on the right side of the bevel gear 60. A rear end of the connecting rod 62 is pivotably coupled, via a needle bearing 67, to an intermediate portion (segment) of the eccentric shaft 61 at a central position of the main-body housing 8 in the left-right direction. As shown in FIGS. 3 and 5, a small (tip) portion of the counterweight 63, which is opposite of the main weight part of the counterweight 64, is fixed to the right-end part of the eccentric shaft 61. A washer 68 supports the bevel gear 60 on side of the interior housing 9a.

In addition, the reciprocating-motion converting mechanism 3 comprises, inside the front-half portion 11 of the gear housing 9: a linking pin 69, rollers 70, 70, roller guides 71, 71, and a slider guide 72. The linking pin 69 passes through the connecting rod 62 in the left-right direction, and couples the front end of the connecting rod 62 to the rear end of the slider 4. The two rollers 70, 70 are respectively fixed to the left and right ends of the linking pin 69 after it has been passed through the slider 4. The roller guides 71, 71 are U-shaped in a plan view and are affixed, such that they face one another, to the inner surfaces of the left and right interior housings 9a, 9b. The roller guides 71, 71 mate with (hold, movably guide) the rollers 70 and thereby guide the movement of the rollers 70, 70 in the front-rear direction. The slider guide 72 has a tube shape and is held inside the front-half portion 11 forward of the roller guides 71, 71. The slider 4 passes through the slider guide 72 and protrudes frontward therefrom. A blade-mounting part (blade clamp) 73 is provided at the tip of the slider 4, and a saw blade (not shown) can be mounted in (inserted into) and dismounted (removed, extracted) from the blade-mounting part 73.

Furthermore, a shoe 74, through which the blade passes and that is configured to make contact with the workpiece, is provided between the lower surface of the front-half portion 11 and the insulation cover 12 such that the position of the shoe 74 in the front-rear direction is adjustable.

Opposite of the shoe 74 in the up-down direction, an LED 75 faces forward at an upper-side front end of the front-half portion 11. A wiring path 76 is formed rearward of the LED 75, and wires are wired (extend) rearward, from the LED 75. These wires pass through the wiring path 76 and are routed from the upper side of the gear housing 9 and rearward of the rear-half portion 10, then extend toward the lower side and are connected to the control circuit board 21. A shield 77, which directs the light from the LED 75 toward the front side, is provided, together with a safety guard that prevents the user's fingers from getting in the way of the saw blade, such that the shield 77 projects from the upper side of the LED 75 of the insulation cover 12.

In the reciprocating saw 1 configured as described above, when the trigger 16 is pulled by a finger that grasps the handle part 15 and the switch 5 is turned on, electric current is supplied from the battery pack 7 to the motor 2, and the rotary shaft 45 rotates. That is, the microcontroller of the control circuit board 21 ascertains the rotational state of the rotor 36 by acquiring the rotation-detection signals, which are output from the rotation-detection devices of the sensor circuit board 47 and indicate the positions of the permanent magnets of the rotor 36, and the rotor 36 is caused to rotate by controlling the ON/OFF states of the switching devices in accordance with the acquired rotational state so as to sequentially supply electric current to the coils 40 of the stator 35.

When the rotary shaft 45 rotates in this manner, the reciprocating-motion converting mechanism 3 operates as follows. The bevel gear 60 is rotated by the pinion 45a that meshes with the gear part (gear teeth) 66 such that the rotational speed of the rotational output of the motor 2 is reduced. Owing to the rotation of the bevel gear 60, the eccentric shaft 61, and thus also the rear end of the connecting rod 62, move (orbit) eccentrically about the rotational axis of the bevel gear 60. Consequently, the connecting rod 62 transmits the portion of the orbiting movement in the front-rear direction to the slider 4. That is, because the rollers 70, 70 on the front end of the connecting rod 62 are guided in the roller guides 71, 71, the rotary motion of the bevel gear 60 is converted into the reciprocating motion of the slider 4 in the front-rear direction, thereby reciprocally moving the slider 4 and the saw blade mounted thereon and making it possible to cut the workpiece.

It is noted that, during operation, the counterweight 63 rotates in a mirror symmetrical manner with the reciprocating motion of the slider 4, thereby inhibiting the transmission of vibration in the front-rear direction from the slider 4 to the user's hand. More specifically, when the rotary shaft 45 causes the bevel gear 60 to rotate from the rotational position shown in FIG. 5 (i.e. where the slider 4 is located at its rearmost position in the front-rear direction and the counterweight 63 is located at its forward-most position in the front-rear direction), the eccentric pin 61 and connecting rod 62 drive the slider 4 forward while the rotation of the bevel gear 60 causes the counterweight 63 (in particular, its center of gravity) to rotate rearward. Thus, when the bevel gear 60 has been rotated by 180° from the state shown in FIG. 5, the counterweight 63 will be located at its rearmost position in the front-rear direction and the slider 4 will be located at its forward-most position in the front-rear direction. Thus, by oppositely (mirror-symmetrically) moving the counterweight 63 relative to the slider 4 in the front-rear direction, vibration caused by the reciprocation of the slider 4 can be offset or canceled out.

That is, as can be understood from the design of the counterweight 63 shown in FIG. 5, the center of gravity of the counterweight 63 in the front-rear direction moves oppositely to the center of gravity of the slider 4 during operation. Therefore, when the center of gravity of the counterweight 63 in the front-rear direction is moving frontward, the slider 4 is moving rearward and vice versa, thereby offsetting or counteracting vibrations generated by the reciprocating movement of the slider 4 in the front-rear direction, so that such vibrations are not transmitted to the user.

In addition, when the centrifugal fan 51 rotates as the rotary shaft 45 rotates, outside air is sucked in from (through) the rear air-suction ports 23 and the front air-suction ports 55. The outside air from the rear air-suction ports 23 passes on the left and the right of the controller 6 and cools the controller 6, after which it enters the interior of the motor housing 30 via the opening 42 of (into) the motor housing 30. The outside air from the front air-suction ports 55 rises upward and then also enters the interior of the motor housing 30 via the opening 42. Thereby, the combined flow of outside air from the front and the rear air-suction ports 55, 23 passes between the stator 35 and the rotor 36 inside the motor housing 30, cools the motor 2, and then arrives in the fan housing chamber 53 and is discharged from (through) the left and right air-exhaust ports 54, 54.

The rotational axis of the rotary shaft 45 of the motor 2 is positioned (oriented) along a straight line in the up-down direction that is orthogonal to the rotational axis of the bevel gear 60 of the reciprocating-motion converting mechanism 3. The motor 2 is disposed on the lower side of the reciprocating-motion converting mechanism 3 and the slider 4 in the up-down direction. Owing to this positional relationship, the motor 2 and the reciprocating-motion converting mechanism 3 overlap in a plan (top) view of the saw 1. Therefore, the motor 2, which includes the motor housing 30, does not protrude rearward beyond the rear end of the gear housing 9. In view of this design, the size (length) of the main-body housing 8 in the front-rear direction can be made smaller than conventional reciprocating saws (in which the motor is disposed rearward of the reciprocating-motion converting mechanism), thereby making the main-body housing 8 more compact and easier to handle, e.g., in confined locations.

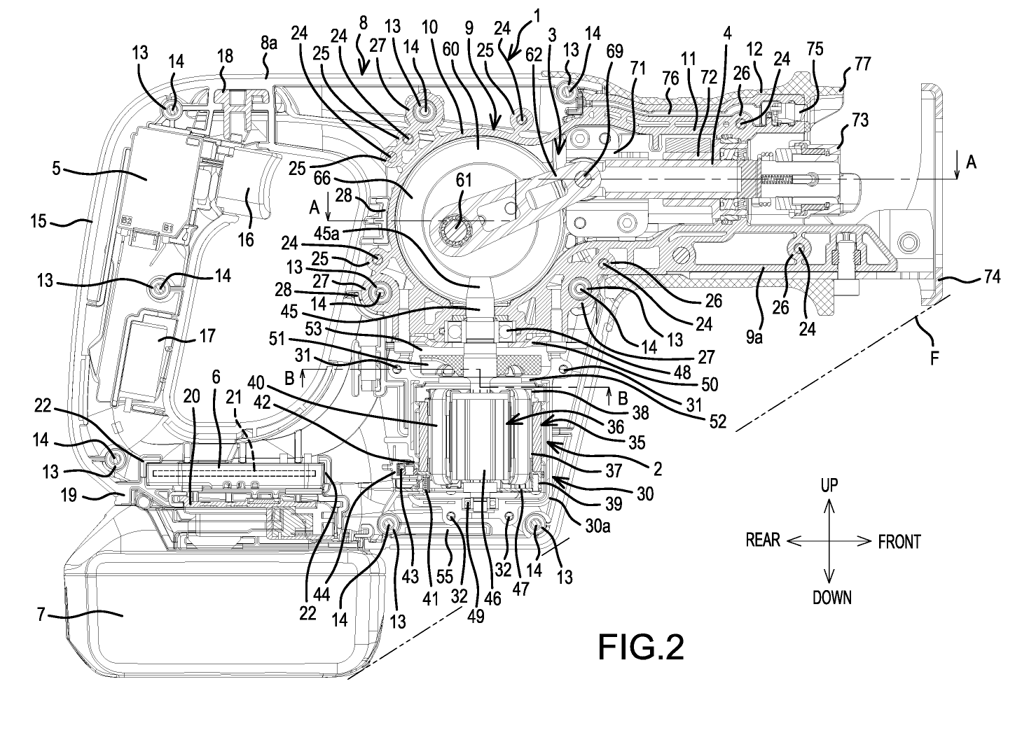

In addition, even though the motor 2 is located on the lower side of the reciprocating-motion converting mechanism 3, the risk that the frontward portion of the main-body housing 8 adjacent the motor housing 30 will strike the ground first in case the reciprocating saw 1 is dropped is small, because the frontward, lower portion of the main-body housing 8 is located, in side view, inward of a virtual plane (line) F (see FIG. 2) that intersects the front lower end of the battery pack 7 and the front lower end of the shoe 74.

Thus, in one aspect of the above-described embodiment, it is noted that the reciprocating saw 1 comprises: the brushless motor 2 comprising the stator 35 and the rotor 36, which is rotatable relative to the stator 35 and has the rotary shaft 45; the reciprocating-motion converting mechanism 3, which is driven by the rotation of the rotary shaft 45; and the slider 4, which is reciprocally moved in the front-rear direction by the reciprocating-motion converting mechanism 3. By disposing the motor 2 downward of the slider 4 such that the rotary shaft 45 is oriented in the up-down direction, the motor 2 is located on the lower side of the reciprocating-motion converting mechanism 3 and is not located rearward of the reciprocating-motion converting mechanism 3. Consequently, the overall length of the reciprocating saw 1 in the reciprocating-motion direction (the front-rear direction) of the slider 4 can be shortened. In addition, if the motor 2 is configured as a brushless motor, the saw 1 can be made more lightweight and compact in the up-down direction.

It is further noted that the reciprocating-motion converting mechanism 3 is housed in the gear housing 9, and the slider 4 protrudes forward therefrom. The motor 2 is housed in the motor housing 30, which is coupled to the lower portion of the gear housing 9. Furthermore, the gear housing 9 and the motor housing 30 are housed in the main-body housing 8, which has the switch 5 and the control circuit board 21 disposed in a rear portion thereof. Consequently, the gear housing 9 and the motor housing 30 can be made into (assembled as) a unit, and the main-body housing 8 can be assembled more easily during manufacture.

In addition or in the alternative, it is noted that the gear housing 9 extends in the front-rear direction and protrudes forward from the main-body housing 8. Furthermore, the motor housing 30 is disposed (located, connected) forward of the rear end of the gear housing 9. Therefore, the motor housing 30, which comprises the motor 2, can be arranged in a compact manner in the front-rear direction such that it does not protrude, in a plan view of the saw 1, from (beyond) the front or the rear ends of the gear housing 9.

Moreover, in another aspect of the above-described embodiment, it is noted that the reciprocating saw 1 comprises: the motor 2, which comprises the stator 35 and the rotor 36, which is rotatable relative to the stator 35 and has the rotary shaft 45 extending in the up-down direction; the pinion 45a, which is provided on the upper end of the rotary shaft 45; the vertically oriented bevel gear 60, with which the pinion 45a meshes and having the rotational axis oriented in the left-right direction; the eccentric shaft 61, which is provided on the bevel gear 60 and moves (orbits) eccentrically around the rotational axis of the bevel gear 60 when the bevel gear 60 is rotated by the pinion 45a; and the slider 4, which is reciprocally moved in the front-rear direction by the front-rear reciprocating movement of the eccentric shaft 61 (e.g. transmitted via the connecting rod 62). In this aspect, the pinion 45a on the upper end of the rotary shaft 45 (that extends in the up-down (vertical) direction) meshes with the bevel gear 60, such that the motor 2 is located on the lower side of the bevel gear 60 and not rearward of the bevel gear 60. Therefore, the overall length in the reciprocating-motion direction (the front-rear direction) of the slider 4 can be shortened. Again, if the motor 2 is configured as a brushless motor, the saw 1 can be made lightweight and compact in the up-down direction.

Again, because the motor 2 is disposed downward of the axis of the bevel gear 60 and because the pinion 45a on the upper end meshes with the lower portion of the bevel gear 60, a highly compact arrangement can be achieved because the motor 2 does not protrude, in a plan view of the saw 1, from (beyond) the front or rear ends of the bevel gear 60.

It is noted that, in the above-described embodiment, the rotary shaft of the motor is disposed (oriented) in the up-down direction, but the rotary shaft does not necessarily have to be precisely in the vertical direction, and compactness in the front-rear direction dimension can be achieved even with a tilted attitude in which the rotary shaft is tilted at a prescribed angle toward the front side, the rear side, etc. For example, the rotational axis (left-right direction) of the rotary shaft and the longitudinal axis (front-rear direction) of the slider may form an angle of between 45-135°, more preferably 60-120°, even more preferably 80-100° and even more preferably 85-95°.

In addition or in the alternative, the motor is not limited to being disposed on the lower side of the reciprocating-motion converting mechanism and may instead be disposed on the upper side thereof. Furthermore, rotary input to the reciprocating-motion converting mechanism may be provided directly from the rotary shaft that is oriented downwardly.

In addition or in the alternative, it is noted that the reciprocating-motion converting mechanism of the above-described embodiment has a structure in which the eccentric shaft provided on (attached to) the bevel gear is coupled to the slider via the connecting rod. However, for example, a cam plate may instead be provided that extracts (transmits) only the component of movement in the reciprocating-motion direction (front-rear direction) of the slider and absorbs (does not transmit) the component of movement in the orthogonal direction (up-down direction) of the slider (e.g., a plate body wherein the eccentric shaft is inserted with a clearance in an elongated hole extending in the orthogonal direction and that is capable of sliding in the reciprocating-motion direction), and the slider may be coupled to the cam plate.

In addition or in the alternative, the motor is not limited to a brushless motor and may be a commutator motor. Furthermore, the battery pack(s) may have different rated voltages, two of the battery packs may be mounted at the front and the rear, and the like. Of course, the power supply is not limited to the battery pack, and the present invention can also be adapted to a reciprocating saw that uses a commercial (AC) power supply.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved power tools.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### EXPLANATION OF THE REFERENCE NUMBERS

1 Reciprocating saw
2 Motor
3 Reciprocating-motion converting mechanism
4 Slider
5 Switch
6 Controller
7 Battery pack
8 Main-body housing
9 Gear housing
10 Rear-half portion
11 Front-half portion
13 Screw boss
14, 24 Screw
21 Control circuit board
27 Mating tube
30 Motor housing
35 Stator
36 Rotor
40 Coil
45 Rotary shaft
45a Pinion
60 Bevel gear
61 Eccentric shaft
62 Connecting rod
63 Counterweight
66 Gear part

1. A reciprocating saw comprising:
a brushless motor comprising a stator and a rotor, which is rotatable relative to the stator and comprises a rotary shaft;
a reciprocating-motion converting mechanism driven by rotation of the rotary shaft; and
a slider that is reciprocally moved in a front-rear direction by the reciprocating-motion converting mechanism;
wherein the brushless motor is disposed downward of the slider, with the rotary shaft oriented in an up-down direction that is perpendicular to the front-rear direction.

2. The reciprocating saw according to claim 1, wherein:
the reciprocating-motion converting mechanism is housed in a gear housing, from which the slider protrudes forward;
the brushless motor is housed in a motor housing that is coupled to a lower portion of the gear housing; and
the gear housing and the motor housing are housed in a main-body housing having a switch and a control circuit board disposed in a rear portion thereof.

3. The reciprocating saw according to claim 2, wherein:
the gear housing extends in the front-rear direction and protrudes forward from the main-body housing; and
the motor housing is located forward of the rear end of the gear housing in the front-rear direction.

4. A reciprocating saw comprising:
a motor comprising a stator and a rotor, which is rotatable relative to the stator and comprises a rotary shaft that extends in an up-down direction of the reciprocating saw;
a pinion provided on an upper end of the rotary shaft in the up-down direction;
a vertically oriented gear that meshes with the pinion and whose rotational axis is oriented in a left-right direction that is perpendicular to the up-down direction;
an eccentric shaft that is provided on the gear and orbits eccentrically around the rotational axis of the gear; and
a slider that is reciprocally moved in a front-rear direction by the eccentric shaft, the front-rear direction being perpendicular to both the up-down direction and the left-right direction.

5. The reciprocating saw according to claim 4, wherein:
the motor is disposed downward of the rotational axis of the gear in the front-rear direction, and
the pinion on the upper end of the rotary shaft meshes with a lower portion of the gear in the up-down direction.

6. A reciprocating saw comprising:
a motor comprising a rotor that is rotatable relative to a stator, a rotary shaft fixedly connected to, and rotatably driven by the rotor, the rotary shaft having a rotational axis;
a reciprocating-motion converting mechanism driven by rotation of the rotary shaft; and
a slider that is reciprocally moved in a first direction by the reciprocating-motion converting mechanism;
wherein the rotational axis and the first direction form an angle of 45-135°.

7. The reciprocating saw according to claim 6, wherein the rotational axis of the rotary shaft and the first direction form an angle of 80-100°.

8. The reciprocating saw according to claim 7, wherein:
a second direction is perpendicular to the first direction,
a third direction is perpendicular to both the first direction and the second direction;
the reciprocating-motion converting mechanism comprises a gear having a rotational axis that extends in the third direction; and
the motor is spaced apart from the gear in the second direction.

9. The reciprocating saw according to claim 8, further comprising:
a gear housing that houses the reciprocating-motion converting mechanism, the slider projecting away from the gear housing in the first direction and having a saw blade clamp at a front end in the first direction;
a motor housing that houses the motor, the motor housing being coupled to the gear housing;
a main-body housing that houses the motor housing and at least partially houses the gear housing; and
a switch and a control circuit board disposed in a rear end portion of the main-body housing in the first direction.

10. The reciprocating saw according to claim 9, wherein:
the gear housing extends in the first direction and protrudes forward from the main-body housing; and
the motor housing is entirely located between a rear end of the gear housing and a front end of the gear housing in the first direction.

11. The reciprocating saw according to claim 10, further comprising:
a pinion disposed on a terminal end of the rotary shaft and meshing with teeth on the gear;
an eccentric shaft mounted on the gear and configured to orbit eccentrically about the rotational axis of the gear when the gear is rotated by the pinion; and
a connecting rod coupling the eccentric shaft to the slider.

12. The reciprocating saw according to claim 11, wherein the teeth of the gear are configured to rotate in a plane defined by the first direction and the second direction.

13. The reciprocating saw according to claim 12, wherein the rotational axis of the rotary shaft and the first direction form an angle of 85-95°.

14. The reciprocating saw according to claim 13, further comprising:
a battery pack mount defined on the main-body housing at a location spaced apart from the gear housing and the slider in the second direction; and
the motor is located between the slider and the battery pack mount in the second direction.

15. The reciprocating saw according to claim 14, wherein:
the motor is disposed downward of the rotational axis of the gear in the second direction, and
the pinion on the upper end of the rotary shaft meshes with a lower portion of the gear in the second direction.

16. The reciprocating saw according to claim 15, wherein:
the gear is a bevel gear,
the motor is a brushless motor,
the rotational axis of the rotary shaft and the first direction form an angle of 85-95°, and
the switch is located in a handle defined at a rear portion of the main body housing in the first direction.

17. The reciprocating saw according to claim 6, wherein:
a second direction is perpendicular to the first direction,
a third direction is perpendicular to both the first direction and the second direction;
the reciprocating-motion converting mechanism comprises a gear having a rotational axis that extends in the third direction; and
the motor is spaced apart from the gear in the second direction.

18. The reciprocating saw according to claim 6, further comprising:
a gear housing that houses the reciprocating-motion converting mechanism, the slider projecting away from the gear housing in the first direction and having a saw blade clamp at a front end in the first direction;
a motor housing that houses the motor, the motor housing being coupled to the gear housing;
a main-body housing that houses the motor housing and at least partially houses the gear housing; and
a switch and a control circuit board disposed in a rear end portion of the main-body housing in the first direction.

19. The reciprocating saw according to claim 18, wherein:
the gear housing extends in the first direction and protrudes forward from the main-body housing; and
the motor housing is entirely located between a rear end of the gear housing and a front end of the gear housing in the first direction.
